(19) United States
(12) Patent Application Publication
(10) Pub. No.: US 2006/0081669 A1
(43) Pub. Date: Apr. 20, 2006

(54) Vehicular computer support assembly

(76) Inventor: Lawrence Dale (Larry) Rissler, Sumner, WA (US)

Correspondence Address: Larry Rissler, 17816 26th St. Ct. E., Sumner, WA, 98390, US

(21) Appl. No.: 11/188,475

(22) Filed: Jul. 25, 2005

Related U.S. Application Data
(60) Provisional application No. 60/620,392, filed on Oct. 19, 2004.

(51) Int. Cl. B60R 7/00

(52) U.S. Cl. 224/275; 224/42.32; 224/572

(57) ABSTRACT

An invention to provide temporary portable attachment for securing multimedia devices to a vehicle's interior between seats, front or rear storage compartment/console, arm rest, bench seats or passenger seat. The vehicle computer support assembly is laid onto the center console and temporarily attached by straps, buckles, and hooks. The multimedia devices are than placed and secured within the vehicular computer support assembly. The vehicle computer support assembly is now ready for use by the driver for directional assistance, a passenger's entertainment through DVDs, CDs, educational interaction software, or work related software programs. The rear extension provides entertainment or work related opportunities. The lap table extends the computer securing and stability to outside a vehicle's interior.

This patent claims benefit of the filing date of provisional patent application Nos. 60/620,392, dated Jul. 30, 2004 and 60/620/392, dated Oct. 19, 2004.

### FIELD OF THE INVENTION

The present invention is generally directed to vehicular computer support assemblies, and more particularly to the vehicular computer support assembly for securing of laptop computers, multimedia devices, such as digital video disc ()VD) players, compact disc (CD) players, gaming devices, and stand alone navigation system equipment, (hereinafter “multimedia devices”) into all sizes and models of motor vehicles.

### BACKGROUND OF THE INVENTION

The only known previously developed method of attachment of a multimedia device in a vehicle is hard mounting to seat brackets or vehicle floor panels as used in police cars and uses a vertical or bent tubing (round or square stock), which is bolted to the seat bracket or floor panel on the passenger side. Attached to the vertical pipe is a horizontally oriented rotating arm with locking devices to counter unwanted movements. A mounting plate for the multimedia devices is disposed at the distal end of the rotating arm.

This type of mounting is not conducive to usage in private vehicles due to the room it requires, which would interfere with the passenger's comfort. An alternative method for using a multimedia device in private vehicles is to lay the multimedia device on the passenger's seat (if unoccupied) which leaves the device freely movable and subject to harm and danger for both the device and driver/operator. Still another method for using a laptop in a private vehicle is to have the passenger hold the computer for the driver and have the passenger relay information from the computer to the driver.

Thus, there exists a need for a vehicular computer support assembly, which permits the efficient and easy use of multimedia devices in a motor vehicle.

One case in point is in regard to the use of global positioning systems (GPS) in vehicles. If a vehicle is not equipped with an in-car GPS unit, there is no alternate method of obtaining GPS information other than by using a hand held GPS device. Hand held GPS devices are very small and hard to view. Thus, there exists a need for a vehicular computer support assembly which permits the use of a larger screen in a private vehicle and that allows a driver to view GPS applications on a screen and view easily without squinting. This allows the driver to find their current location and their destination without distraction.

### SUMMARY OF THE INVENTION

The present invention relates to an apparatus and method of securing multimedia devices to a motor vehicle's interior components for usage by the vehicle driver, such as for GPS applications on multimedia devices. Also the vehicle passenger or rear seat occupants can watch DVDs and listen to CDs, or play video games by using the vehicular computer support assembly.

In the illustrated embodiment, the vehicular computer support assembly attaches to the vehicle, by coupling to the storage lid, arm rest, passenger seat, or center console (hereinafter “center console”) of the vehicle by extension arms, straps, or rods on both sides or front and rear locations of the base plate. After securing the base plate, a multimedia device is installed into the cradle and secured by the cradle's rear bolts. The vehicular computer support assembly now can be positioned for convenient viewing such as of a GPS application for the driver, or turned so the passenger can enjoy entertainment, such as DVDs, CDs, interactive videos, educational software, or to accomplish work related tasks.

One embodiment formed in accordance with the present invention of a system of attachment of multimedia devices within a motor vehicle is provided. The system includes a rotating cradle adapted to secure multimedia devices within a motor vehicle's interior. The system may further include attachment assemblies, which may include one or more hooks and straps, or assemblies, that temporarily secure the base plate to a motor vehicle's front seat center console/storage compartment. The system may also include a vertical support leg for computer weight stabilization. The system may still further include an attachment assembly of securing the base plate to a vehicle's rear seat passenger compartment. The system may additionally include attachment assemblies for securing a base plate to a motor vehicle's rear seat chair arms or rear seat center console/storage compartment. The system may still yet include a belt strap for coupling to a vehicle's rear seat passenger compartment. Additionally the base plate may be used alone as a portable lap table. The multimedia devices are positioned in the center of the base plate and rotated 90 degrees toward the user. Leg cutouts resist side movements due in part to movement of aircraft, trains, buses, vanpool transports, and private conveyance methods.

### BRIEF DESCRIPTION OF THE DRAWINGS

The foregoing aspects and many of the attendant advantages of this invention will became better understood by reference to the following detail description, when taken in conjunction with the accompanying drawings, wherein:

FIG. 1, is a side view of one embodiment of a vehicular computer support assembly formed in accordance with present invention with a computer secured to the vehicular computer support assembly and the vehicle computer support assembly attached to a vehicle interior center console:

FIG. 2, is a isometric view of the vehicular computer support assembly of FIG. 1, with the computer and cradle of the vehicle computer support assembly removed:

FIG. 3, is a isometric view of the vehicular computer support assembly rotatable cradle.

FIG. 4, is a isometric view of the vehicular computer support assembly with the cradle in an elevated position:

FIG. 5, is an isometric view of the vehicular computer support assembly of FIG. 2 with the cradle in a lowered position:

FIG. 6, is an isometric view of the vehicular computer support assembly of FIG. 2, with an additional rear computer support assembly attached thereto;

FIG. 7, is a side view of the vehicular computer support assembly of FIG. 1 with the additional rear computer support assembly and dual multimedia devices in the different positions:

FIG. 8, is a side view of the vehicular computer support assembly of FIG. 1 attached to a vehicle's armrest.

FIG. 9, is a side view of the vehicular computer support assembly lap table positioned on the users lap/legs.

### DETAILED DESCRIPTION OF THE PREFERRED EMBODIMENT

All attachments of parts herein referred to as assemblies and fastened points will either be secured, bonded, bolted, attached, integrally formed, and/or temporarily secured by any suitable means, a few suitable examples being gluing, fusing, bolts, screws, hooks, and hinges.

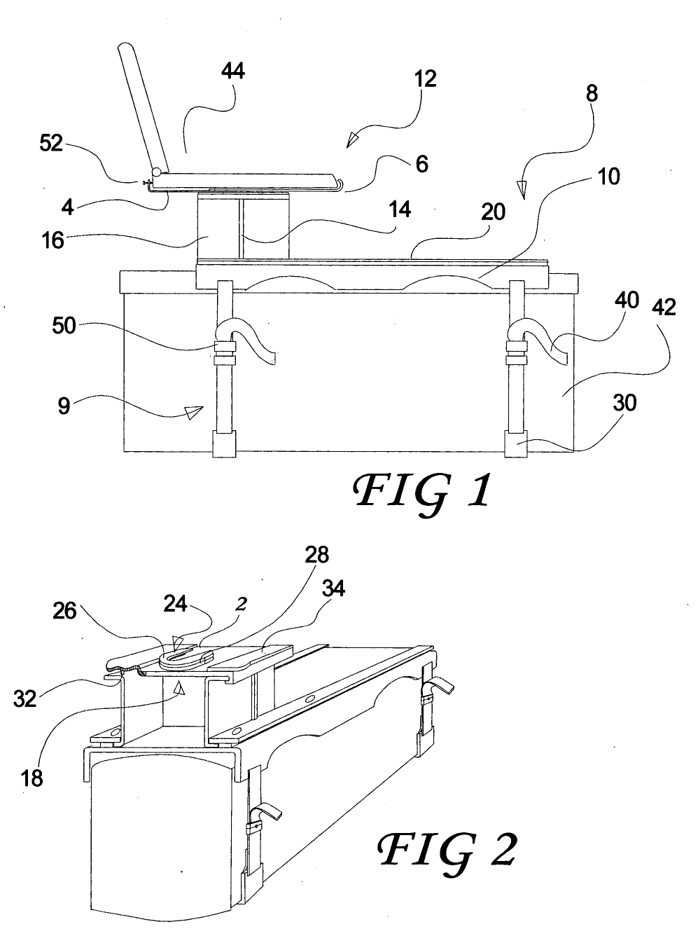

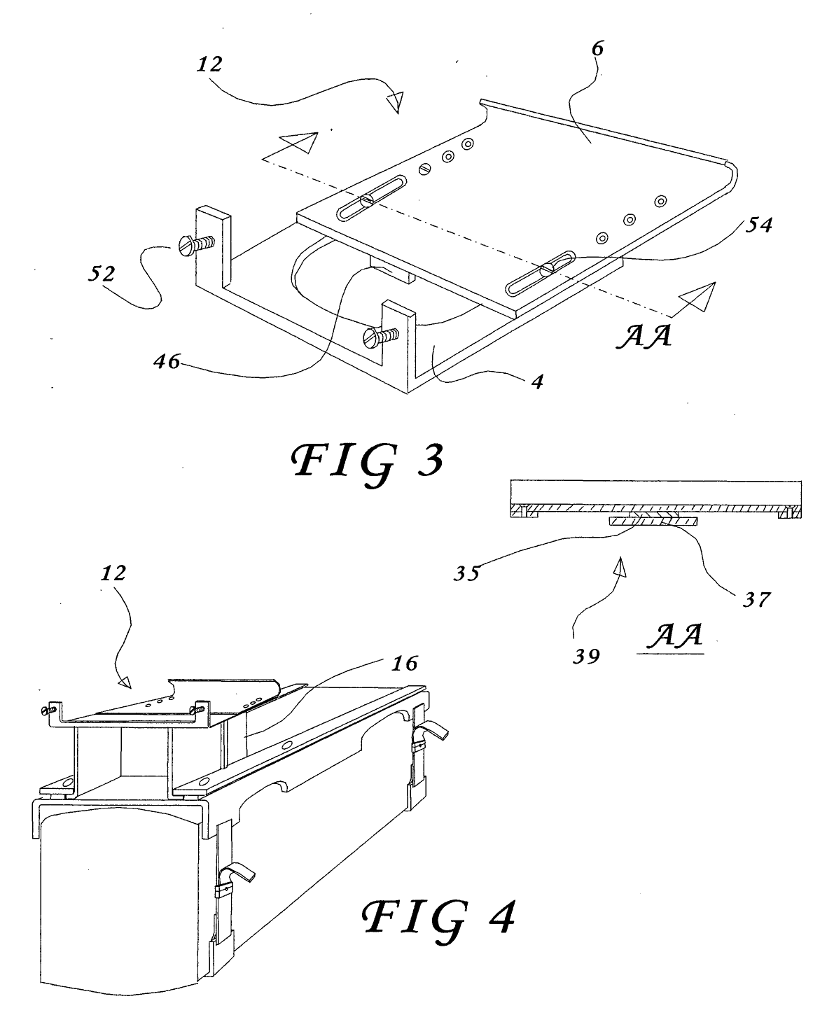

Referring to FIG. 1, a side view of a vehicular computer support assembly 8 is shown. The vehicular computer support assembly 8, is an alternate embodiment of vehicular computer support assembly disclosed in U.S. Provisional Patent Application No. 60/593,013 and 60/620/392, the disclosure of which is hereby expressly incorporated by reference. The vehicular computer support assembly 8, includes a base plate 10, “T” rails 20, and a cradle assembly 12, which may rotate after attachment to horseshoe coupler assembly 24, (See FIGS. 2, and 3,) or any suitable means to base plate 10. At each end of the base plate 10, a plurality of attachment assemblies 9, each attachment assembly 9, including a hook 30, a strap 40, and a buckle 50, are used to couple the base plate 10, to a vehicle's interior center console 42. The base plate 10 is attached to the center console 42 by first placing the base plate 10, on the top of the interior center console 42, then inserting hooks 30, between the bottom edge of the center console and vehicle's floor/carpet. Straps 40, are then tightened by selectively drawing the straps 40,through securing buckles 50, thereby securing the vehicular computer support assembly 8, to the center console 42. The computer 44, is then installed into the cradle assembly 12, and secured in place by tightening screws 52. The vehicular computer support assembly 8 uses riser walls 16 to raise the level of the computer cradle assembly 12. More specifically, a plurality of riser walls 16 are slid between base plate 10, and “T” rails 20,and spacer plate 14, is inserted within channels of walls 16, to maintain separation between walls 16, and alignment in notch cutouts in “T” rails 20, to extend upward therefore. A index plate 18, assembly is then slid onto the distal edges of the riser walls 16. Riser walls 16 and index plate 18, are provided to elevate the computer cradle 12, to a height for rotation above the seats in vehicles having low level interior center consoles 42.

Referring to FIG. 2, top index assembly 18, consists of slide plate 2, index tab handles 34, index tabs 32, horseshoe assembly 24, with lower horseshoe plate 26, and upper horseshoe plate 28. Top index assembly plate 18, is slid onto the upper lips of walls 16, and index tabs 32 index to holes located in upper lip of walls 16, by means of tab index handles 34.

Referring to FIG. 3, an isometric view of the vehicular computer support assembly with cradle assembly 12, and cut away view AA. Cradle assembly 12, consist of forward plate 6, aft plate 4, securing screws 54, and extraction tab 46. Forward plate 6, is adjustable to fit the wide range of multimedia devices depths and is secured in place by securing screws 54. Cradle assembly 12 with forward plate 6, toward horseshoe 24, is inserted into horseshoe assembly 24, than rotated 180 degrees and thereby entrapping extraction tab 46 behind horseshoe assembly 24. This entrapment will not allow cradle assembly 12 to be removed from horseshoe coupler 24, until rotated nearly the 180 degrees.

Referring to FIG. 4, an isometric view of the vehicular computer support assembly with the cradle assembly 12, installed in an elevated position, the cradle assembly 12, is inserted into horseshoe coupler 24, and than turned 180 degrees to entrap securing tab 46, behind horseshoe coupler 24, (see FIG. 3).

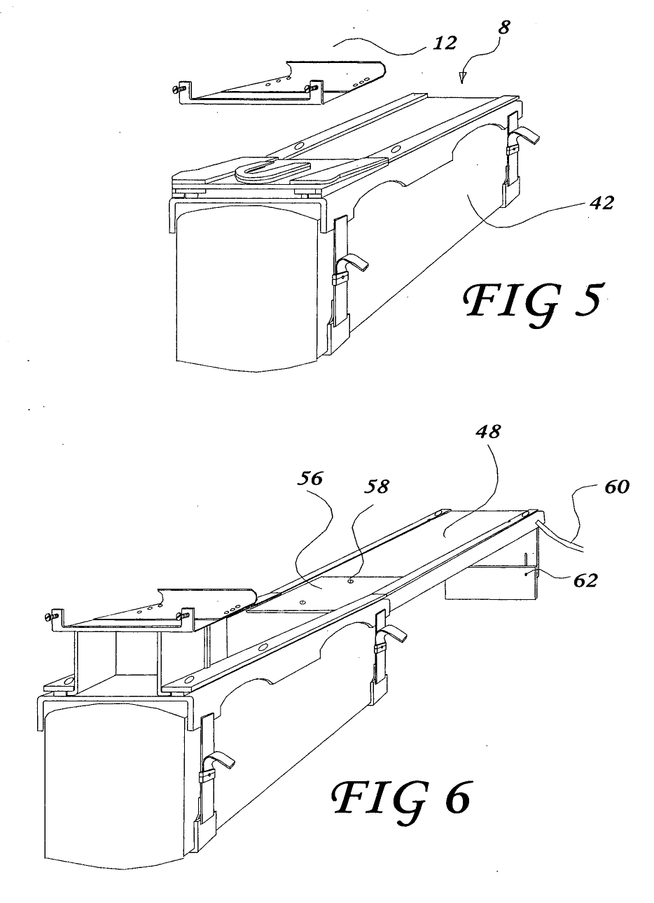

Referring to FIG. 5, an isometric view of the vehicular computer support assembly which does not use the riser walls 16 of FIG. 1-3, is shown. This embodiment is preferably used with interior center consoles 42, which are higher in height.

Referring to FIG. 6, an isometric view of an alternate embodiment of a vehicular computer support assembly which includes a rear extension assembly 49, is shown. The rear extension assembly 49, includes an extension base plate 48, a vertical support plate 60, and adjustment plate 62, secured in place by a suitable fastener, such as fastener 54, as shown in FIG. 3.

Referring to FIG. 7, a side view of the vehicular computer support assembly with both assemblies 8, and 49, attached is shown. The rear portion of assembly 49 is held in place by means of hook(s) 30, strap(s) 40, and securing buckle(s) 50. Hook(s) 30, are held securely under the rear passenger seat edge 66, by adjusting the tension of the strap 40.

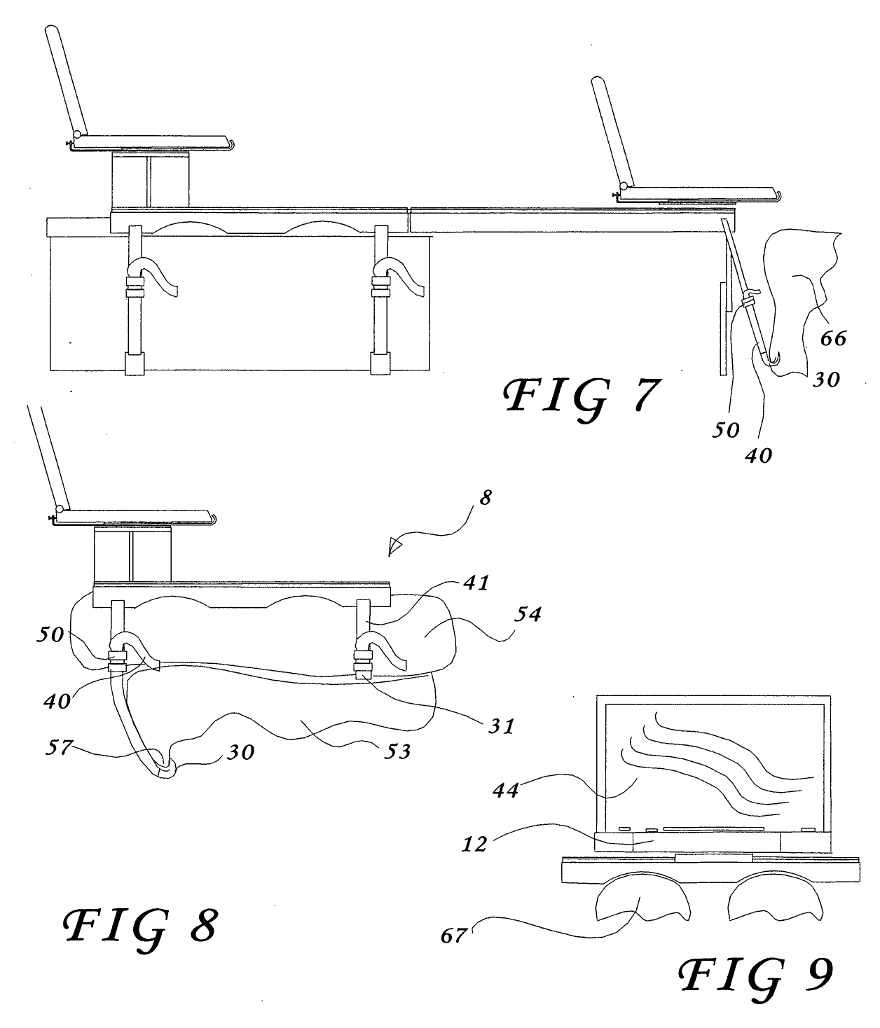

Referring to FIG. 8, a side view of a vehicular computer support assembly 8 used with a vehicle without an interior center console is shown. Assembly 8, is secured around armrest 54, by means of a rear strap 40, with hooks 30, attached together to make a continuous strap. Forward strap 40, hook 30, and securing buckle 50, attach under the front seat edge 53.

Referring to FIG. 9, a side view of a vehicular computer support assembly with cradle assembly 12, positioned in the middle of assembly 8. Computer 44, is rotated toward the user and the entire assembly can be set on the user's lap/legs 67.

What is claimed is:

1. A system for attachment of a wide range of multimedia devices, which could include (but not limited to) laptop computers, DVDs with attached viewing devices and CD players, portable gaming devices, stand alone navigation systems within a motor vehicle, said system comprising of:
a. Base plate assembly to secure a multimedia device within a motor vehicle's interior.
b. Secures multimedia devices in motor vehicles in a non-destructive manner that requires no parts removal and reinstallation of vehicle components.

2. The system of claim 1, further comprising a rotating cradle attached to the base plate. This allows both the driver and passenger access to the computer at a easy rotation to their viewing positions.

3. The system of claim 1, further comprising attachment straps which temporarily secure base plate to a motor vehicle's front seat center console/storage compartment. The average time required for installation averages between 4 and 5 minutes of the vehicular computer support assembly. The installation requires little or no mechanical ability and requires normal human strength.

4. A system for attachment of an extension base plate onto the forward base plate for rear compartment passengers to use a multimedia devices.

5. The system of claim 5, further comprising a vertical support leg in the rear for computer weight stabilization.

6. A system of claim 6, further comprising attachment arms, straps, hooks, or buckles to secure the base plate to a motor vehicle's rear seat captain chair arms or rear seat center console/storage compartment.

7. The system of claim 6, further comprising securing belts attachment for front or rear compartment bench seat configuration.

8. The lap table (assembly 8, and 12,) is for use internal or external to a vehicle, such as, air, car, bus, train, or any other means of transportation. Positioning the multimedia devices in the middle of the lap table helps stabilize the weight on the users lap/legs and reduces the effects of side and for/aft vehicle movement on the computer. This vehicle movement has been a headache for multimedia device users and the lap table will reduce the operational strain accompanied with normal levels of operation.

9. A system where the materials used in the vehicular computer support assembly are non-metallic (but not limited to) and therefore will not setoff the currently used scanner equipment when traveling.

10. A system of parts that disassemble to a small enough area to fit into a multimedia device large bag along with the multimedia devices or strap to smaller multimedia device bags or briefcases.

11. A system that is light enough to be considered carry-on luggage in air travel.

12. This system can be used in new vehicles where the manufacturer did not offer as a factory option, onboard navigational systems or multimedia devices.
While referred embodiments of the invention have been illustrated and described, it will be appreciated that various changes can be made therein in a variety of forms. Therefore, while this invention has been described in connection with particular examples thereof, the true scope of the invention should not be so limited since other modifications will become apparent to the skilled practitioner upon a study of the drawing, specifications and following claims without departing from the sprit and scope of the invention.
